(19) United States
(12) Patent Application Publication
(10) Pub. No.: US 2026/0058050 A1
(43) Pub. Date: Feb. 26, 2026

(54) COIL COMPONENT

(71) Applicant: TDK Corporation, Tokyo (JP)

(72) Inventors: Kazuhiro YOSHIKAWA, Tokyo (JP); Naoaki FUJII, Tokyo (JP); Nobuya TAKAHASHI, Tokyo (JP); Hironori SATO, Tokyo (JP); Yuuichi KAWAGUCHI, Tokyo (JP)

(21) Appl. No.: 19/102,872

(22) PCT Filed: Apr. 17, 2023
(86) PCT No.: PCT/JP2023/015315

§ 371 Date: Feb. 11, 2025

(30) Foreign Application Priority Data
Aug. 29, 2022 (JP) 2022-135660

(51) Int. Cl. H01F 27/32; H01F 27/255; H01F 27/29

(52) U.S. Cl. CPC H01F 27/324; H01F 27/255; H01F 27/292

(57) ABSTRACT

A coil component includes: a magnetic element body M having a mounting surface; a coil pattern embedded in the magnetic element body; a conductor post embedded in the magnetic element body and whose one end is connected to the coil pattern; a post protective film provided between the conductor post and the magnetic element body; a cover insulating film covering the mounting surface of the magnetic element body; and a terminal electrode provided on the cover insulating film and connected to the other end of the conductor post through an opening of the cover insulating film. The post protective film is made of an insulating material different from that of the cover insulating film.

### TECHNICAL FIELD

The present disclosure relates to a coil component and, more particularly, to a coil component having a structure in which a coil pattern and a conductor post connected to both ends of the coil pattern are embedded in a magnetic element body.

### BACKGROUND ART

Patent Document 1 discloses a coil component having a structure in which a coil pattern and a conductor post connected to both ends of the coil pattern are embedded in a magnetic element body. In patent Document 1, an insulating film is interposed between the conductor post and the magnetic element body to maintain insulation therebetween.

### CITATION LIST

### Patent Document

[Patent Document 1] JP 2020-155509A

### DISCLOSURE OF THE INVENTION

### Problem to be Solved by the Invention

In the coil component described in Patent Document 1, a terminal electrode connected to the conductor post is brought into contact with the mounting surface of the magnetic element body.

In the present disclosure, there is described a technology for further improving, in a coil component having a structure in which a coil pattern and a conductor post are embedded in a magnetic element body, insulation performance between the conductor post and the magnetic element body and between a terminal electrode and the magnetic element body.

### Means for Solving the Problem

A coil component according to an aspect of the present disclosure includes: a magnetic element body having a mounting surface; a coil pattern embedded in the magnetic element body; a conductor post embedded in the magnetic element body and whose one end connected to the coil pattern; a post protective film provided between the conductor post and the magnetic element body; a cover insulating film covering the mounting surface of the magnetic element body; and a terminal electrode provided on the cover insulating film and connected to the other end of the conductor post through an opening formed in the cover insulating film. The post protective film is made of an insulating material different from that of the cover insulating film.

According to the present disclosure, insulation performance between the conductor post and the magnetic element body and between the terminal electrode and the magnetic element body is further improved.

In the present disclosure, the thermal expansion coefficient of the post protective film may be lower than that of the cover insulating film, and the Young's modulus of the cover insulating film may be lower than that of the post protective film. This further increases product reliability.

In the present disclosure, the other end of the conductor post may be flush with the mounting surface of the magnetic element body. This enhances flatness of the mounting surface of the magnetic element body.

In the present disclosure, the post protective film may be thicker than the cover insulating film. This further increases product reliability.

The coil component according to one aspect of the present disclosure may further include an interlayer insulating film provided between the coil pattern and magnetic element body, and the post protective film may be made of the same insulating material as that of the interlayer insulating film. This can reduce manufacturing cost.

In the present disclosure, the post protective film may have a tapered shape in which the film thickness thereof decreases from its one end toward the other end. This can prevent the occurrence of a void in the magnetic element body.

In the present disclosure, the cover insulating film may contain a magnetic filler. This can further increase inductance.

The coil component according to one aspect of the present disclosure may further include another cover insulating film covering the upper surface of the magnetic element body that is positioned on a side opposite the mounting surface. This further increases product reliability.

### Advantageous Effects of the Invention

As described above, according to the present disclosure, there can be provided a technology for further improving, in a coil component having a structure in which a coil pattern and a conductor post are embedded in a magnetic element body, insulation performance between the conductor post and the magnetic element body and between a terminal electrode and the magnetic element body.

### BRIEF DESCRIPTION OF THE DRAWINGS

FIG. 1 is a schematic perspective view for explaining the outer appearance of a coil component 1 according to a first embodiment of the present disclosure.

FIG. 2A is a schematic cross-sectional view of the coil component 1 according to one example.

FIG. 2B is a schematic cross-sectional view of the coil component 1 according to another example.

FIG. 3 is a schematic plan view for explaining the pattern shape of the conductor layer C0.

FIG. 4 is a schematic plan view for explaining the pattern shape of the conductor layer C1.

FIG. 5 is a schematic plan view for explaining the pattern shape of the conductor layer C2.

FIG. 6 is a schematic plan view for explaining the pattern shape of the conductor layer C3.

FIG. 7 is a process view for explaining the manufacturing method for the coil component 1.

FIG. 8 is a process view for explaining manufacturing method for the coil component 1.

FIG. 9 is a process view for explaining the manufacturing method for the coil component 1.

FIG. 10 is a process view for explaining the manufacturing method for the coil component 1.

FIG. 11 is a process view for explaining the manufacturing method for the coil component 1.

FIG. 12 is a process view for explaining the manufacturing method for the coil component 1.

FIG. 13 is a process view for explaining the manufacturing method for the coil component 1.

FIG. 14 is a process view for explaining the manufacturing method for the coil component 1.

FIG. 15 is a process view for explaining the manufacturing method for the coil component 1.

FIG. 16 is a schematic cross-sectional view of a post protective film 15 having a tapered shape.

FIG. 17 is a schematic cross-sectional view of a coil component 2 according to a second embodiment of the present disclosure.

### MODE FOR CARRYING OUT THE INVENTION

Hereinafter, some embodiments of the present disclosure will be described in detail with reference to the accompanying drawings.

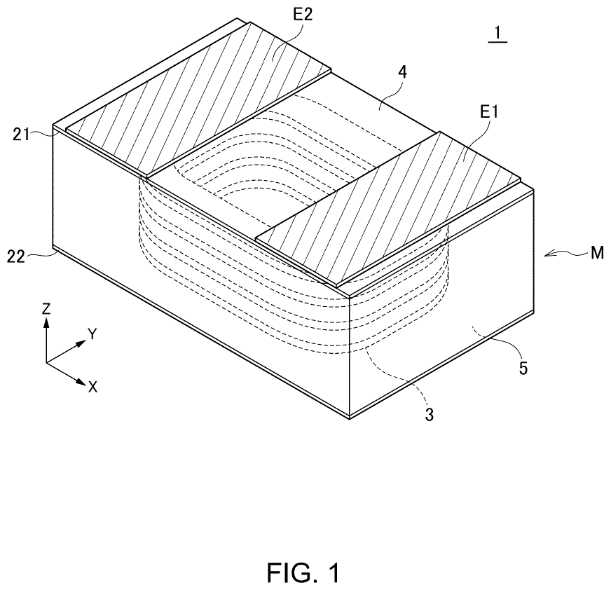

FIG. 1 is a schematic perspective view for explaining the outer appearance of a coil component 1 according to a first embodiment of the present disclosure.

As illustrated in FIG. 1, the coil component 1 according to the first embodiment is a chip-type coil component having a structure in which a coil part 3 having a coil axis extending in the Z-axis is embedded in a magnetic element body M. The magnetic element body M has a mounting surface 4 and an upper surface 5 which are perpendicular to the coil axis and constitute the XY plane. The mounting surface 4 and upper surface 5 are positioned on mutually opposite sides. Terminal electrodes E1 and E2 are provided on the mounting surface 4. At the time of mounting, the terminal electrodes E1 and E2 are made to face a circuit board and soldered thereto. That is, the vertical direction of the coil component 1 illustrated in FIG. 1 differs by 180° from that at the time of mounting.

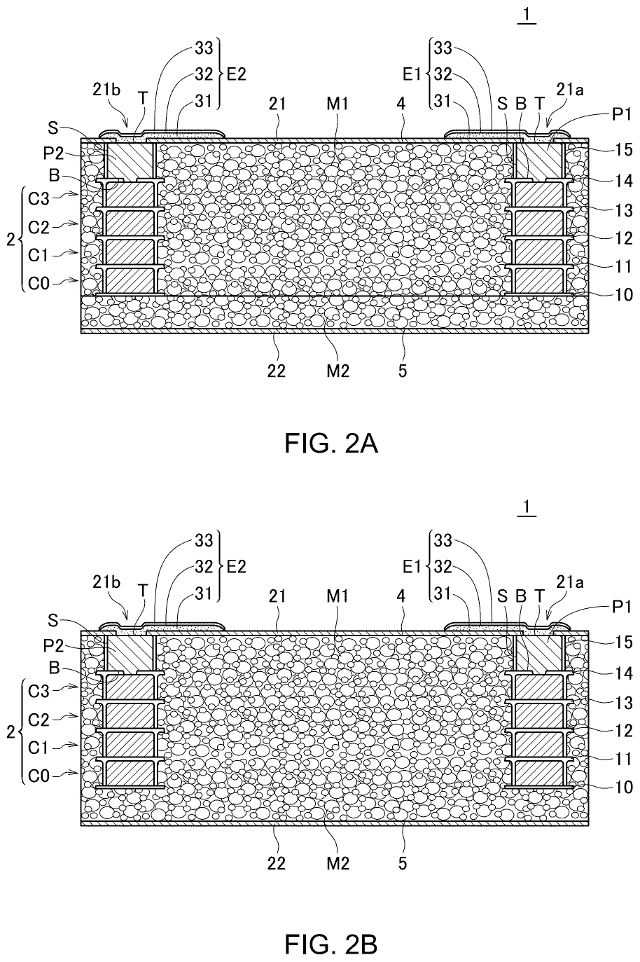

FIG. 2A is a schematic cross-sectional view of the coil component 1 according to the present embodiment.

As illustrated in FIG. 2A, the coil component 1 according to the first embodiment has the coil part 3 including interlayer insulating films 10 to 14 and conductor layers C0 to C3 which are alternately stacked in the coil axis direction (Z-direction). The conductor layers C0 to C3 are made of Cu or the like. The magnetic element body M includes magnetic resin layers M1 and M2. The magnetic resin layer M1 is provided in the inner diameter area of the coil part 3, the radially outside area of the coil part 3, and one side of the coil part 3 in the coil axis direction. The magnetic resin layer M2 is provided at the other side of the coil part 3 in the coil axis direction. The magnetic resin layers M1 and M2 are made of a composite magnetic material containing a magnetic filler and a binder resin. The composite magnetic materials constituting the magnetic resin layers M1 and M2 may be the same as or different from each other. As the magnetic filler, a metal magnetic material such as iron (Fe) or a permalloy-based material can be used. As the binder resin, epoxy resin can be used. The magnetic resin layers M1 and M2 need not have a clear boundary therebetween. For example, when the magnetic resin layers M1 and M2 are made of the same material, they may be united without a clear boundary therebetween.

Conductor posts P1 and P2 are embedded in the magnetic resin layer M1. The conductor posts P1 and P2 are pillar-shaped conductors made of Cu or the like and extending in the Z-direction. A lower surface B, which is one end of the conductor post P1, is connected to one end of the coil formed by the conductor layers C0 to C3, and a lower surface B, which is one end of the conductor post P2, is connected to the other end of the coil formed by the conductor layers C0 to C3. On the other hand, upper surfaces T, which are the other ends of the conductor posts P1 and P2, are exposed from the mounting surface 4 so as to be flush with the mounting surface 4 and connected respectively to the terminal electrodes E1 and E2. Side surfaces S (surfaces along the Z-direction) of the conductor posts P1 and P2 are covered with a post protective film 15. Since the post protective film 15 is thus interposed between the conductor posts P1, P2 and the magnetic element body M, contact between the conductor posts P1, P2 and the magnetic element body M is prevented to achieve insulation therebetween. When the coil component 1 according to the present embodiment having the conductor posts P1 and P2 is mounted on a circuit board or the like, stress is relaxed by the conductor posts P1 and P2 to reduce damage to the coil part 3. This increases mounting reliability of the coil component 1.

The mounting surface 4 and upper surface 5 of the magnetic element body M are covered with cover insulating films 21 and 22, respectively. The cover insulating film 22 covers substantially the entire upper surface 5, while the cover insulating film 21 has openings 21a and 21b at positions overlapping respectively the conductor posts P1 and P2. As a result, the upper surfaces T (XY plane) of the respective conductor posts P1 and P2 are exposed through the respective openings 21a and 21b of the cover insulating film 21. On the cover insulating film 21, the terminal electrodes E1 and E2 are provided. The terminal electrodes E1 and E2 are each constituted by a resin electrode 31 containing metal powder of Ag and binder resin, an Ni film 32, and an Sn film 33. The Ni film 32 and Sn film 33 are formed on the surface of the resin electrode 31. The terminal electrodes E1 and E2 are connected to the upper surfaces T of the respective conductor posts P1 and P2 respectively through the openings 21a and 21b of the cover insulating film 21. The upper surface 5 of the magnetic element body M need not necessarily be covered with the cover insulating film 22; however, providing the cover insulating film 22 increases reliability and allows a direction mark or the like to be attached to the upper surface 5.

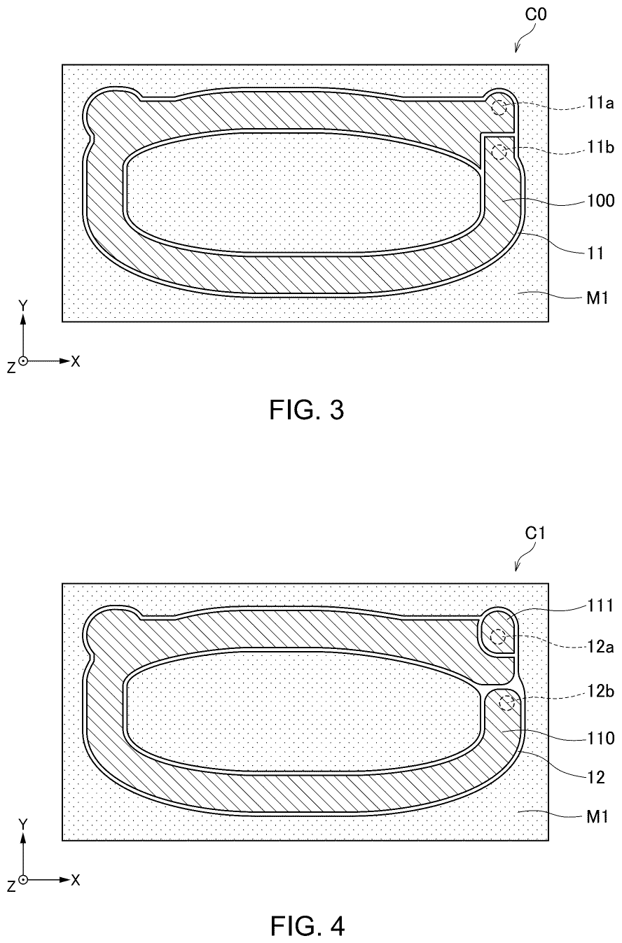

FIGS. 3 to 6 are schematic plan views for explaining the pattern shapes of the respective conductor layers Co to C3.

As illustrated in FIG. 3, the conductor layer C0 is provided with a coil pattern 100. The coil pattern 100 is a pattern wound in about one turn, and both ends thereof are connected to the conductor layer C1 through vias 11a and 11b formed in the interlayer insulating film 11.

As illustrated in FIG. 4, the conductor layer C1 is provided with a coil pattern 110 and a connection pattern 111. The coil pattern 110 is a pattern wound in about one turn. One end of the coil pattern 110 is connected to the other end of the coil pattern 100 in the conductor layer C0 through the via 11b formed in the interlayer insulating film 11, and the other end thereof is connected to the conductor layer C2 through a via 12b formed in the interlayer insulating film 12. The connection pattern 111 is provided at a position overlapping the one end of the coil pattern 100 in the conductor layer C0. The connection pattern 111 is connected to the one end of the coil pattern 100 in the conductor layer C0 through a via 11a formed in the interlayer insulating film 11 and to the conductor layer C2 through a via 12a formed in the interlayer insulating film 12.

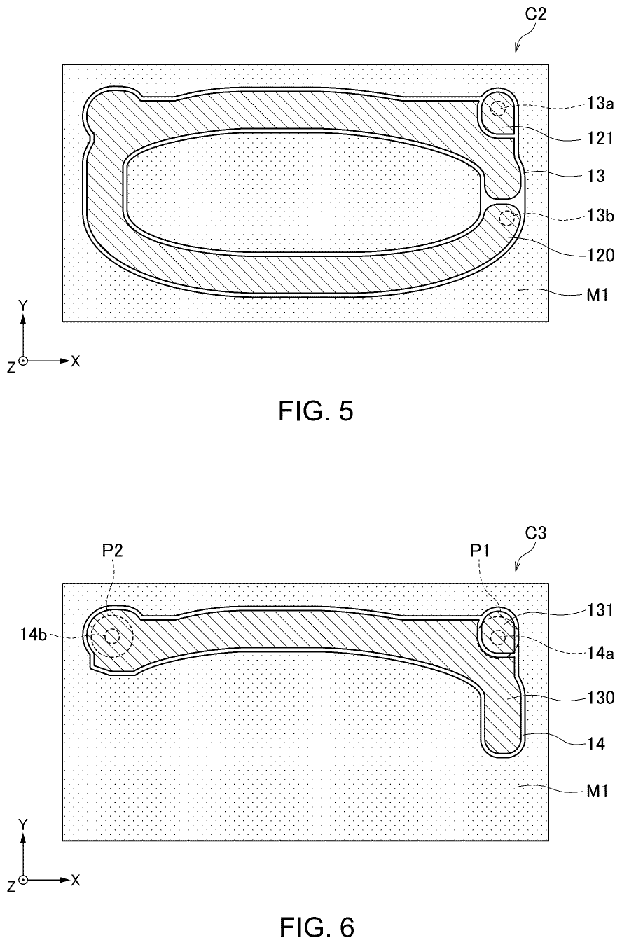

As illustrated in FIG. 5, the conductor layer C2 is provided with a coil pattern 120 and a connection pattern 121. The coil pattern 120 is a pattern wound in about one turn. One end of the coil pattern 120 is connected to the other end of the coil pattern 110 in the conductor layer C1 through the via 12b formed in the interlayer insulating film 12, and the other end thereof is connected to the conductor layer C3 through a via 13b formed in the interlayer insulating film 13. The connection pattern 121 is provided at a position overlapping the connection pattern 111 provided in the conductor layer C1. The connection pattern 121 is connected to the connection pattern 111 in the conductor layer C1 through the via 12a formed in the interlayer insulating film 12 and to the conductor layer C3 through a via 13a formed in the interlayer insulating film 13.

As illustrated in FIG. 6, the conductor layer C3 is provided with a coil pattern 130 and a connection pattern 131. The coil pattern 130 is a pattern wound in about 0.5 turns. One end of the coil pattern 130 is connected to the other end of the coil pattern 120 in the conductor layer C2 through the via 13b formed in the interlayer insulating film 13, and the other end thereof is connected to the conductor post P2 through a via 14b formed in the interlayer insulating film 14. The connection pattern 131 is provided at a position overlapping the connection pattern 121 provided in the conductor layer C2. The connection pattern 131 is connected to the connection pattern 121 in the conductor layer C2 through the via 13a formed in the interlayer insulating film 13 and to the conductor post P1 through a via 14a formed in the interlayer insulating film 14.

With the above configuration, the coil patterns 100, 110, 120, and 130 are connected in series between the terminal electrodes E1 and E2 to form a coil of about 3.5 turns in total. The coil component 1 according to the present embodiment is an embedded-type coil component in which the coil part 3 including the alternately stacked interlayer insulating films 10 to 14 and conductor layers C0 to C3 is embedded in the magnetic element body M, which is different in structure from a stacked-type coil component in which magnetic sheets made of ceramic or the like and coil patterns are alternately stacked. For example, in the stacked-type coil component, a magnetic sheet is interposed between coil patterns adjacent in the stacking direction, while in the coil component 1 according to the present embodiment, coil patterns adjacent in the stacking direction are insulated by the interlayer insulating film, and the magnetic element body M is not interposed between the coil patterns. Further, the coil component 1 according to the present embodiment is also different in structure from a sheet coil of a type in which a coil pattern is formed on a printed board.

In the present embodiment, the coil patterns 100, 110, 120, and 130 and connection patterns, 111, 121, and 131 constituting the coil part 3 are insulated from the magnetic element body M by the interlayer insulating films 10 to 14, the conductor posts P1 and P2 are insulated from the magnetic element body M by the post protective film 15, and the terminal electrodes E1 and E2 are insulated from the magnetic element body M by the cover insulating film 21. Thus, all the conductor patterns are insulated from the magnetic element body M, allowing achievement of high insulating performance.

Although the interlayer insulating films 10 to 14, post protective film 15, and cover insulating films 21 and 22 are not particularly limited in material, the post protective film 15 and cover insulating films 21 and 22 are made of mutually different insulating materials in the present embodiment. This is because the post protective film 15, which is embedded in the magnetic element body M and contacts the conductor posts P1 and P2, and the cover insulating films 21 and 22, which constitute the outermost layer of the coil component 1, are different in characteristics required to increase product reliability.

Specifically, for the post protective film 15, an insulating material containing a filler made of an inorganic material such as silica and thus having a low thermal expansion coefficient is selected, whereby it is possible to reduce a difference in thermal expansion coefficient from Cu which is the material of the conductor posts P1 and P2. On the other hand, for the cover insulating films 21 and 22, a photosensitive resin material with a low Young's modulus is selected, whereby it is possible to enhance physical protection characteristics of the magnetic element body M on the mounting surface 4 and upper surface 5 and to facilitate the formation Of the openings 21a and 21b. Thus, the post protective film 15 is preferably made of an insulating material having a lower thermal expansion coefficient than the cover insulating films 21 and 22, and the cover insulating films 21 and 22 are preferably made of an insulating material having a lower Young's modulus than the post protective film 15. Further, by adding a magnetic filler to an insulating material constituting the cover insulating films 21 and 22, inductance can be further increased.

Since the interlayer insulating films 10 to 14 are embedded in the magnetic element body M and contact the coil patterns 100, 110, 120, and 130 and the connection patterns 111, 121, and 131, they may be made of the same insulating material as that of the post protective film 15. When the interlayer insulating films 10 to 14 and post protective film 15 are made of the same insulating material, material cost can be reduced.

The following describes a manufacturing method for the coil component 1 according to the present embodiment.

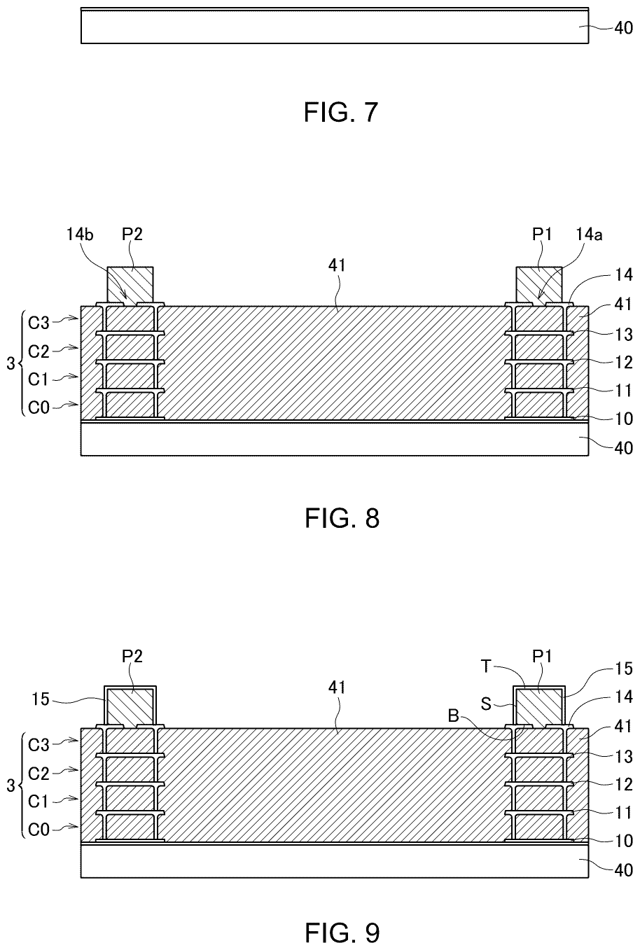

FIGS. 7 to 15 are process views for explaining the manufacturing method for the coil component 1 according to the present embodiment. Although FIGS. 7 to 15 each illustrate only an area corresponding to one coil component 1, a plurality of coil components 1 are actually manufactured at the same time using an aggregate substrate.

A support substrate 40 is prepared (FIG. 7), and the interlayer insulating films 10 to 14 and the conductor layers C0 to C3 are alternately formed on the surface of the support substrate 40 to form the coil part 3. After that, the vias 14a and 14b are formed in the interlayer insulating film 14, and the conductor posts P1 and P2 are formed (FIG. 8). The conductor layers C0 to C3 and conductor posts P1 and P2 can be formed by electrolytic plating. The conductor layers C0 to C3 include a sacrificial pattern 41 positioned in the inner diameter area of the coil part 3 and in the outside area of the coil part 3.

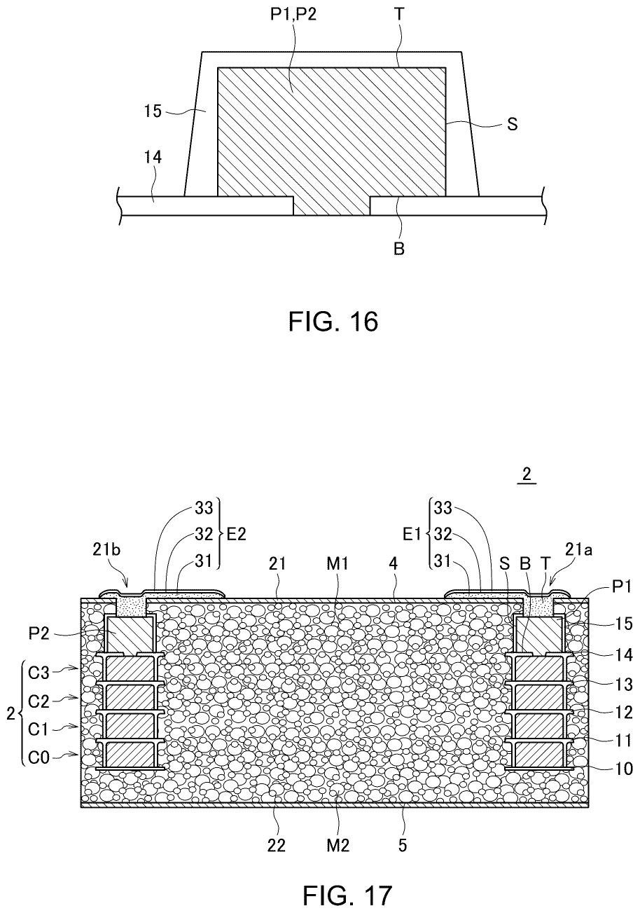

Then, the post protective film 15 covering the entire exposed surface of each of the conductor posts P1 and P2 is formed (FIG. 9). The entire exposed surface of each of the conductor posts P1 and P2 includes the side surface S along the Z-direction and the upper surface T constituting the XY plane. The post protective film 15 may have a constant film thickness as illustrated in FIG. 9 or may be formed into a tapered shape as illustrated in FIG. 16 in which the film thickness thereof decreases from the lower surface B of each of the conductor posts P1 and P2 toward the upper surface T thereof, that is, from one end of each of the conductor posts P1 and P2 toward the other end thereof. When the post protective film 15 is formed into a tapered shape as illustrated in FIG. 16, a void is less likely to be generated during embedding of the magnetic resin layer MI to be described later. The film thickness of the post protective film 15 refers to the film thickness in a direction perpendicular to the surfaces of the conductor posts P1 and P2.

In this state, wet etching is performed to remove the Sacrificial pattern 41 (FIG. 10). The conductor patterns constituting the coil part 3 are covered with the interlayer insulating films 10 to 14 and thus will not be etched. Similarly, the conductor posts P1 and P2 are covered with the post protective film 15 and thus will not be etched. As a result, a space 42 is formed in the inner diameter area and outside area of the coil part 3.

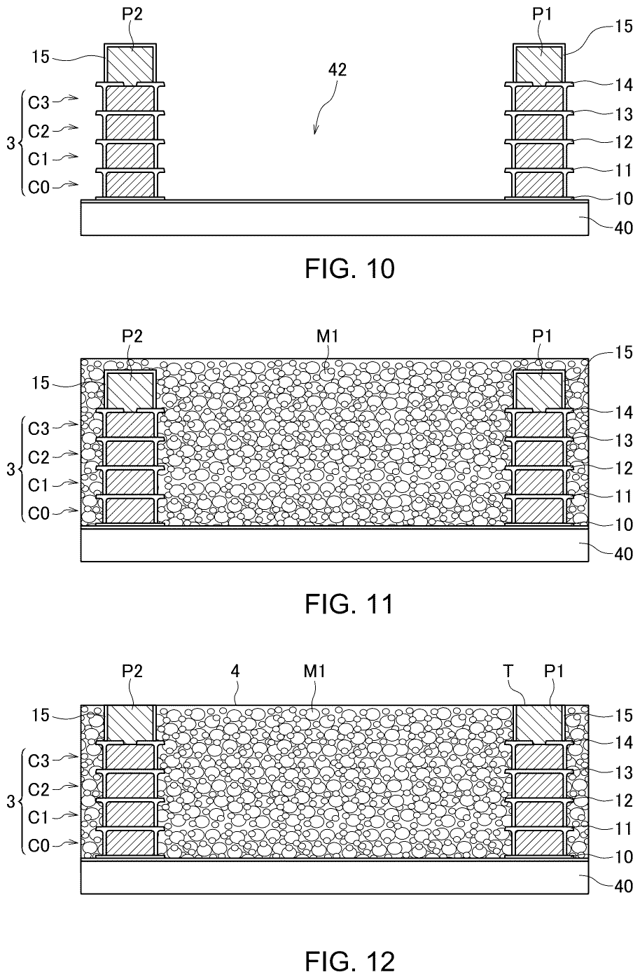

Then, the space 42 formed as a result of the removal of the sacrificial pattern 41 is filled with the magnetic resin layer M1 (FIG. 11). Then, the surface of the magnetic resin layer M1 is polished until the conductor posts P1 and P2 are exposed (FIG. 12). As a result, the mounting surface 4 of the magnetic resin layer M1 and the upper surfaces T of the conductor posts P1 and P2 become flush with one another. Further, as compared with a state before polishing, flatness of the magnetic resin layer M1 on the mounting surface 4 side is significantly enhanced.

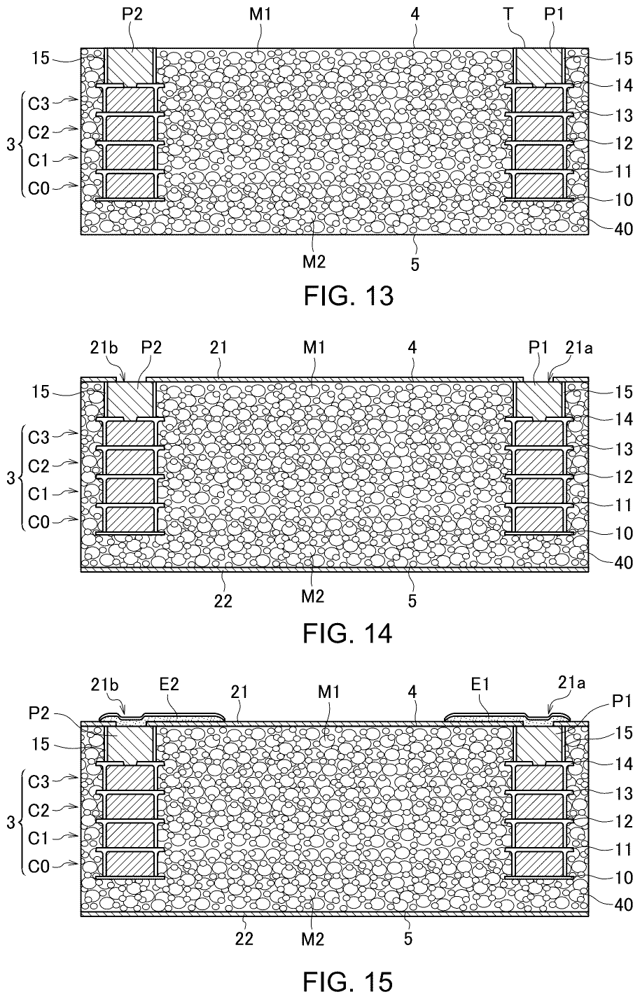

Then, the support substrate 40 is removed, and the magnetic resin layer M2 is formed on the lower surface side of the magnetic resin layer M1 so as to cover the interlayer insulating film 10 (FIG. 13). Thereafter, the surface of the magnetic resin layer M2 may be polished for smoothing the upper surface 5. Then, the cover insulating films 21 and 22 are formed respectively on the mounting surface 4 and upper surface 5 of the magnetic element body M, and the openings 21a and 21b are formed in the cover insulating film 21 so as to expose therethrough a part of the upper surface T of each of the conductor posts P1 and P2 (FIG. 14). As described above, flatness of the magnetic resin layer M1 on the mounting surface 4 side is significantly enhanced by polishing, so that the cover insulating film 21 may have a reduced thickness. This can reduce the entire thickness of the coil component 1. On the other hand, the thickness of the post protective film 15 needs to be large to some extent since it functions as a resist for protecting the conductor posts P1 and P2 at the time of removal of the sacrificial pattern 41 illustrated in FIG. 10. Thus, the film thickness of the post protective film 15 may be larger than that of the cover insulating film 21.

Then, the terminal electrodes E1 and E2 are formed on the cover insulating film 21 so as to be connected respectively to the conductor posts P1 and P2 (FIG. 15), followed by singulation by dicing, whereby the coil component 1 according to the present embodiment is completed.

As described above, in the present embodiment, the post protective film 15 that covers the conductor posts P1 and P2 is not removed but left in place at the time of removal of the sacrificial pattern 41 and, in this state, embedding of the magnetic resin layer M1 is conducted. This can prevent contact between the conductor posts P1, P2 and the magnetic element body M without increasing the number of manufacturing steps. In addition, the terminal electrodes E1 and E2 are formed not directly on the mounting surface 4 but through the cover insulating film 21, making it possible to also prevent contact between the terminal electrodes E1, E2 and the magnetic element body M.

FIG. 17 is a schematic cross-sectional view of a coil component 2 according to a second embodiment of the present disclosure.

As illustrated in FIG. 17, the coil component 2 according to the second embodiment differs from the coil component 1 according to the first embodiment in that the upper surfaces T of the conductor posts P1 and P2 are partially covered with the post protective film 15 and magnetic element body M and that the terminal electrodes E1 and E2 are connected respectively to the conductor posts P1 and P2 penetrating through the magnetic element body M and post protective film 15. Other basic configurations are the same as those of the coil component 1 according to the first embodiment, so the same reference numerals are given to the same elements, and overlapping description will be omitted.

As exemplified by the coil component 2 according to the second embodiment, the upper surfaces T Of the conductor posts P1 and P2 need not necessarily be flush with the mounting surface 4 of the magnetic element body M, and they may be partially covered with the post protective film 15 and magnetic element body M. Such a configuration can be obtained as follows: after the process illustrated in FIG. 11, detachment of the support substrate 40 and formation of the cover insulating films 21 and 22 are conducted without polishing, and vias penetrating the magnetic element body M and post protective film 15 are formed at the time of formation of the openings 21a and 21b in the cover insulating film 21 to partially expose the conductor posts P1 and P2.

While some embodiment of the present disclosure has been described, the present disclosure is not limited to the above embodiment, and various modifications may be made within the scope of the present disclosure, and all such modifications are included in the present disclosure.

For example, although the coil part 3 includes four conductor layers C0 to C3 in the above embodiments, the number of conductor layers included in the coil part is not particularly limited to a specific number. Further, although the coil patterns 100, 110, and 120 provided respectively in the conductor layers C0 to C2 are each wound in about one turn in the above embodiments, the number of turns of the coil c pattern provided in each conductor layer is not particularly limited to a specific number.

This application claims the benefit of Japanese Patent Application No. 2022-135660, filed on Aug. 29, 2022, the entire disclosure of which is incorporated by reference herein.

### REFERENCE SIGNS LIST

1, 2 coil component
3 coil part
4 mounting surface
5 upper surface
10-14 interlayer insulating film
11a, 11b, 12a, 12b, 13a, 13b, 14a, 14b via
15 post protective film
21, 22 cover insulating film
21a, 21b opening
31 resin electrode
32 Ni film
33 Sn film
40 support substrate
41 sacrificial pattern
42 space
100, 110, 120, 130 coil pattern
111, 121, 131 connection pattern
B lower surface of conductor post
C0-C3 conductor layer
E1, E2 terminal electrode
M magnetic element body
M1, M2 magnetic resin layer
P1, P2 conductor post
S side surface of conductor post
T upper surface of conductor post

1. A coil component comprising:
a magnetic element body having a mounting surface;
a coil pattern embedded in the magnetic element body;
a conductor post embedded in the magnetic element body and having one end connected to the coil pattern;
a post protective film provided between the conductor post and the magnetic element body;
a cover insulating film covering the mounting surface of the magnetic element body; and
a terminal electrode provided on the cover insulating film and connected to other end of the conductor post through an opening formed in the cover insulating film,
wherein the post protective film is made of an insulating material different from that of the cover insulating film.

2. The coil component as claimed in claim 1,
wherein a thermal expansion coefficient of the post protective film is lower than a thermal expansion coefficient of the cover insulating film, and
wherein a Young's modulus of the cover insulating film is lower than a Young's modulus of the post protective film.

3. The coil component as claimed in claim 1, wherein the other end of the conductor post is flush with the mounting surface of the magnetic element body.

4. The coil component as claimed in claim 3, wherein the post protective film is thicker than the cover insulating film.

5. The coil component as claimed in claim 1, further comprising an interlayer insulating film provided between the coil pattern and magnetic element body,
wherein the post protective film is made of a same insulating material as that of the interlayer insulating film.

6. The coil component as claimed in claim 1, wherein the post protective film has a tapered shape in which the film thickness thereof decreases from the one end toward the other end.

7. The coil component as claimed in claim 1, wherein the cover insulating film contains a magnetic filler.

8. The coil component as claimed in claim 1, further comprising another cover insulating film covering an upper surface of the magnetic element body that is positioned on a side opposite the mounting surface.
